(19) United States
(12) Patent Application Publication
(10) Pub. No.: US 2011/0030233 A1
(43) Pub. Date: Feb. 10, 2011

(54) DRYER DEVICE WITH END OF USE INDICATOR

(75) Inventors: Mengtao Pete He, Scottsdale, AZ (US); Debra Park, Mesa, AZ (US); Joan M. Bergstrom, Phoenix, AZ (US); Pamela Lam, Scottsdale, AZ (US); Michael Dreja, Cologne (DE); Keiran Cornell Hamlett, Tempe, AZ (US); John F. Billman, Scottsdale, AZ (US); Catherine Henwood Todd, Whitefish, MT (US)

Correspondence Address: SNELL & WILMER, LLP (Dial Corp), ONE ARIZONA CENTER, 400 E. VAN BUREN, PHOENIZ, AZ, 85004-2202, US

(73) Assignee: THE DIAL CORPORATION, Scottsdale, AZ (US)

(21) Appl. No.: 12/096,947

(22) PCT Filed: Jan. 9, 2007
(86) PCT No.: PCT/US07/00523

§ 371 Date: Jun. 25, 2009

(30) Foreign Application Priority Data
Jan. 9, 2006 (US) 60766304
Mar. 8, 2006 (US) 60743433
Jul. 20, 2006 (US) 60832238

(51) Int. Cl. F26B 19/00

(52) U.S. Cl. 34/89

(57) ABSTRACT

The invention discloses an end of use indicator (EUI) with a visual cue and a dryer device thereof. The EUI prompts the consumer to refill a cartridge within a device, replace a cartridge within a device, or replace the device itself. In one exemplary embodiment, the present invention teaches a repetitive use, dryer device with an EUI for the treatment of fabrics in a laundry dryer.

### CROSS-REFERENCE TO RELATED APPLICATIONS

This application is a U.S. National Phase filing under 35 U.S.C. 371 and claims priority to PCT Application No. PCT/US2007/000523, entitled “DRYER DEVICE WITH END OF USE INDICATOR,” which was filed on Jan. 9, 2007, which application claims priority to U.S. Provisional Patent Application Ser. No. 60/766,304, entitled “END OF USE INDICATOR,” which was filed on Jan. 9, 2006; U.S. Provisional Patent Application Ser. No. 60/743,433, entitled “END OF USE INDICATOR,” which was filed on Mar. 8, 2006; and, U.S. Provisional Patent Application Ser. No. 60/832,238, entitled “REFILLABLE AND REUSABLE DRYER DEVICE AND REFILL CARTRIDGE,” which was filed on Jul. 20, 2006, all of which are incorporated herein by reference.

### FIELD OF INVENTION

The invention discloses an end of use indicator (EUI) with a visual cue and a dryer device thereof. The EUI prompts the consumer to refill a cartridge within a device, replace a cartridge within a device, or replace the device itself.

### BACKGROUND OF THE INVENTION

Many consumer devices operate continuously requiring a subjective determination of when a device has come to the end of its useful life. At such point, the device must be replaced or refilled. As such, a simple and cost effective end of use indicator (EUI) ensures proper performance of the device and thereby significantly reduces the purchase cycle for a refill or a new device.

### SUMMARY OF THE INVENTION

The present invention teaches a dryer device for the treatment of clothes tumbling in a laundry dryer. In an exemplary embodiment, the dryer device contains a substance in a porous body member to be dispersed throughout the clothes in a laundry dryer. At least a portion of the porous body member acts as a reservoir for the substance, such that the substance can migrate from the body member and in to the dryer to treat the clothes. Moreover, the body member allows for substance to exit the dryer device's body member and treat the clothes in an efficient manner by commingling and tumbling along side the clothes in the dryer. In accordance with other exemplary embodiments, porous body members include, but are not limited to, sponges, foams, sheets, poufs, pouches, and towelettes.

Additionally, the dryer device provides information to the consumer about the product life expectancy with an end of use indicator (EUI), which is visible from the exterior of the body member or from the exterior of a refill cartridge. This allows the consumer to either replace or refill the product in an efficient manner. This information about product life expectancy can be based on the amount of substance remaining in the device or on the number of temperature cycles the device has undergone independent from the amount of substance remaining in the device. As set forth in various exemplary embodiments in the detailed description and accompanying figures, the indication to the consumer of when replacement or refill is necessary can be communicated with a simple visual cue.

### BRIEF DESCRIPTION OF THE DRAWINGS

The subject matter of the present invention is particularly pointed out and distinctly claimed in this disclosure. To facilitate a more complete understanding of the present invention, various non-limiting embodiments are taught in the detailed description, claims and the drawing figures, wherein:

FIG. 1 is another exemplary embodiment illustrating an impermeable barrier separating a substance reservoir from an end of use indicator and body member or wick;

FIG. 2 is an exemplary embodiment illustrating a main body member with a recess for a refill cartridge;

FIG. 3 is an exemplary embodiment illustrating a main body member of the device encased in netting;

FIG. 4 is an exemplary embodiment illustrating a main body member of the device encased in plastic;

FIG. 5 is an exemplary embodiment illustrating a main body member further comprising two segments;

FIG. 6 is an exemplary embodiment illustrating a main body member further comprising two hinged segments;

FIG. 7 is an exemplary embodiment illustrating a main body member comprising two separate segments in a hinged casing;

FIG. 8 is an exemplary embodiment illustrating a hinged casing;

FIG. 9 is an exemplary embodiment illustrating a cartridge of the present invention;

FIG. 10 is an exemplary embodiment illustrating a cartridge further comprising a plastic container;

FIG. 11 is an exemplary embodiment illustrating a cartridge further comprising fabric conditioning substance and end-of-use indicator;

FIG. 12 is a graphical representation illustrating sponge mass loss of substance to be dispersed for a given number of cycles; and

FIG. 13 is a graphical representation illustrating weight loss from various embodiments of the present invention over a number of repeat dryer cycles.

FIG. 14 is a table of formulas and weight percent of compounds used in Example 1.

### DETAILED DESCRIPTION

The detailed description of this disclosure illustrates and teaches various exemplary embodiments and the best modes, known to the inventors at this time. These exemplary embodiment and modes are described in sufficient detail to enable those skilled in the art to practice the invention and are not intended to limit the scope, applicability, or configuration or the invention in any way. Rather, the following disclosure is intended to teach both the implementation of the exemplary embodiments and modes and any equivalent modes or embodiments that are known or obvious to those of reasonably skill in the art. Additionally, all included figures are non-limiting illustrations of the exemplary embodiments and modes, which similarly avail themselves to any equivalent modes or embodiments that are known or obvious to those of reasonably skill in the art.

As used herein, the terms “comprise”, “comprises”, “comprising”, “having”, “including”, “includes”, or any variation thereof, are intended to reference a non-exclusive inclusion, such that a process, method, article, substance or apparatus that comprises a list of elements does not include only those elements recited, but may also include other elements not expressly listed and equivalents inherently known or obvious to those of reasonable skill in the art. Other combinations and/or modifications of structures, arrangements, applications, proportions, elements, materials, or components used in the practice of the instant invention, in addition to those not specifically recited, may be varied or otherwise particularly adapted to specific environments, manufacturing specifications, design parameters or other operating requirements without departing from the scope of the instant invention and are intended to be included in this disclosure.

Moreover, unless specifically noted, it is the Applicant's intent that the words and phrases in the specification and the claims be given the commonly accepted generic meaning or an ordinary and accustomed meaning used by those of ordinary skill in the applicable arts. In the instance where these meanings differ, the words and phrases in the specification and the claims should be given the broadest possible, generic meaning. If any other special meaning is intended for any word or phrase, the specification will clearly state and define the special meaning.

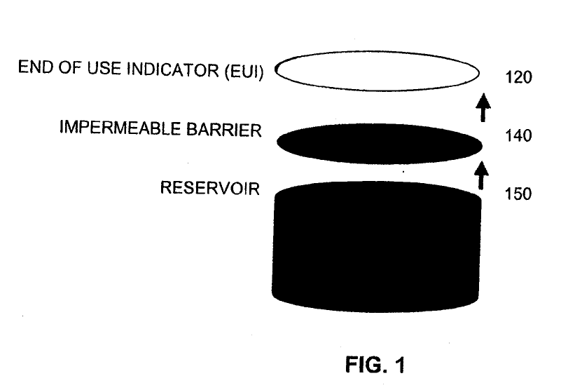

The present invention teaches a dryer device for the treatment of clothes tumbling in a laundry dryer. In an exemplary embodiment, the dryer device contains a substance in a porous body member to be dispersed throughout the clothes in a laundry dryer. With reference to FIG. 1, at least a portion of the porous body member acts as a reservoir 150 for the substance, such that the substance can migrate from the body member in to the dryer to treat clothing by commingling and tumbling along side clothing in a dryer.

Additionally, the dryer device provides information to the consumer about the product life expectancy with an end of use indicator (EUI), which is visible from the exterior of the body member or from the exterior of a refill cartridge. This information about product life expectancy can be based on the amount of substance remaining in the device or on the number of temperature cycles the device has undergone independent from the amount of substance remaining in the device. This allows the consumer to either replace or refill the product in an efficient manner. The indication to the consumer of when replacement or refill is necessary can be communicated with a simple with visual cue. In various exemplary embodiments, the dryer device is replaceable in its entirety before or after prompt by the EUI.

For ease of understanding and clarity, various non-limiting embodiments of each element in the above recited invention overview are provided below.

Visual Cue

Most broadly, the simple visual cue gives the consumer a clear and easily understandable prompt regarding product life expectancy. For example, in accordance with various embodiments, the visual cue can be the substance itself, a chemical that reacts with the substance, or a wholly temperature dependant material, independent of the substance.

In an exemplary embodiment with further reference to FIG. 1, the substance migrates from the reservoir 150 to and/or through the EUI 120 inducing this visual cue. Moreover, this visual cue can be induced by saturating the EUI 120 with substance and allowing the visual cue to fade as substance used by the device. In this mode, the visual cue can be the substance itself including, but not limited to, a colored substance or a color changing substance.

In an alternative exemplary embodiment, the visual cue can be a chemical that reacts with the substance in the reservoir 150. For example, the substance in the reservoir 150 can be colorless and can react upon migration of the appropriate stoichiometric amount into, through, or out of the EUI 120 with a chemical in the EUI 120. This chemical reaction induces a colorimetric change, a visual cue and provides information about the product life expectancy.

In yet another embodiment, the visual cue can be temperature dependant such that it counts and provides information to the consumer regarding the number of dryer cycles completed. In an exemplary embodiment, this temperature dependant visual cue can be a thermal degradable coating. The degradable coating can be at least one of a printed sign, dot, or word, which disappears of fades with use. In another exemplary embodiment, the degradable coating comprises at least one of a polymer, a latex, a wax material, a polyurethane, a poly-urea and an inorganic pigment. The degradable coating can be applied in numerous ways including, but not limited to, by hot coating, by printing, by an in-situ reaction process, by stamping, by painting, or by drawing. In another exemplary embodiment, the degradable coating degrades at the operating temperature of a dryer, preferably greater than about 50° and less than about 80° C.

Those skilled in the art can appreciate that numerous visual cues for providing the consumer a clear and easily understandable prompt regarding product life expectancy, including the methods for creating these visual cues, are contemplated with in the scope of this invention. Additionally, in accordance with various aspects of the present inventions, this temperature dependant visual cue can be used to count and provide information to the consumer regarding equipment that create thermal cycles including, but not limited to, refrigerators, washers, and dryers. This information can be the actual or approximate number of cycles the device has undergone or general product life expectancy information to alert the consumer to replace or refill the product.

Reservoir

As mentioned above, a dryer device in accordance with the present invention may contain a substance in a porous body member to be dispersed throughout the clothes in a laundry dryer. It is often desirable for the consumer to be able to replenish this substance once prompted by the EUI to do so. To that end, in one exemplary embodiment, the dryer device has a refillable or replaceable reservoir. Thus, for example, in one embodiment and with reference to FIG. 1, at least a portion of the porous body member acts as a reservoir 150 for the substance, such that the substance can migrate from the body member in to the dryer to treat clothing.

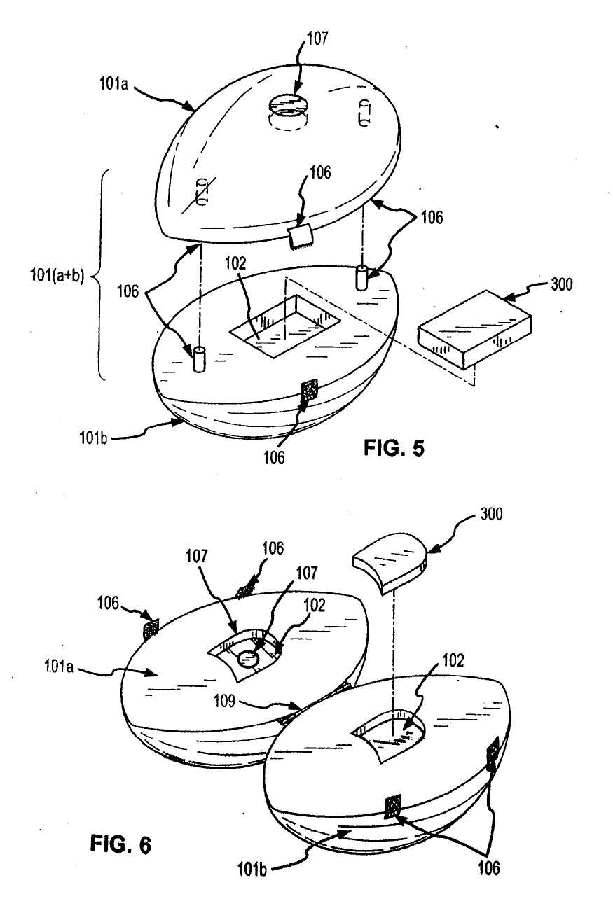

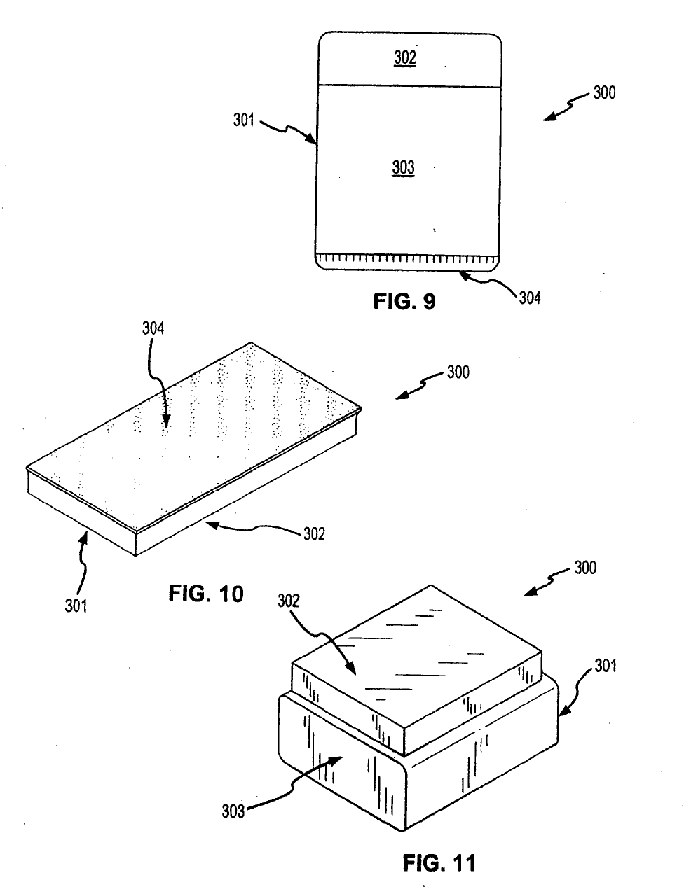

In another exemplary embodiment and with reference to FIG. 9, the reservoir 150 can be a refill cartridge 300 to contain a substance 303 used to treat clothes in a dryer. The cartridge 300 can comprise a housing 301 to maintain the overall cartridge shape and a substance 303. Optionally, the cartridge 300 can further comprise an EUI 302 coupled to the same housing 301 or the EUI 302 can be provided in the device separate from the cartridge 300 to provide information to the consumer about the product life expectancy, as discussed above. In either mode, the EUI 302 is preferably visible to the consumer from the exterior of the body member (see FIG. 5) or from the exterior of the cartridge 300. One exemplary embodiment of a device where the consumer can read the EUI from the exterior of the body member is shown in transparent housing 301 and transparent surface 302, wherein the substance 303 meters out of the cartridge over a number of dryer cycles. Additionally, either mode allows for refilling or replacing the cartridge before or after the EUI indicates to do so.

In another exemplary embodiment, the housing 301 can comprise plastic or a similar material with similar characteristics to maintain the overall cartridge shape and to contain the substance 303. By way of non-limiting example, the plastic is at least one of a polypropylene (PP), a polyethylene (PE), a polypropylene (PP), a polyvinylchloride (PVC), a polystyrene (PS), a polyamide (PA), a polyester, a polyvinyl chloride (PVC), a polycarbonate (PC), a polymethyl methacrylate (PMMA), a polytetrafluoroethylene (PTFE), a polyvinylidene chloride (PVDC), an acrylonitrile butadiene styrene (ABS) and a polyethylene terephthalate (PET or PETE). Alternatively, the housing 301 is optional, whereas the cartridge can be a solid block substance 303. For example, in a preferred embodiment, the substance 303 comprises a block of solid fabric conditioner and the housing 301 is either degraded by gradual use of the device or comprises a frame structure to hold substance 303.

In an additional embodiment and in reference to FIG. 9 and FIG. 10, the substance 303 reservoir is shipped with a barrier 304 to prevent evaporation of the substance 303 and the EUI 302 is not activated until consumer use begins. For example, the reservoir can be sealed with a barrier 304, which can be removed by the consumer or can be permeated by the heating action of the dryer.

Those skilled in the art can appreciate that any reservoir or reservoir configuration for dispersing substance throughout clothes in a laundry dryer is contemplated with in the scope of this invention.

Barrier

As mentioned above, it may be desirable to have a refillable cartridge that can be shipped without loss of substance (i.e., through evaporation or other means) and, if the cartridge includes a EUI, than it is generally desirable to not activate the EUI until first consumer use of the refill cartridge. In this respect, in an exemplary embodiment and with reference to FIG. 1, a barrier 140 between the reservoir 150 and the EUI 120 is disclosed to avoid loss of substance and to halt EUI activation until first consumer use. As such, in an exemplary embodiment, barrier 140 is impermeable and removal of the impermeable barrier 140 initiates migration of the substance from the reservoir 150. In another example, a disposable sticker acts as impermeable barrier 140, for example, as part of a refillable component.

Additionally, in order to increase the ease of using the device the barrier 140 can be configured to become permeable after the device is used. In an exemplary embodiment, the impermeable barrier 140 can thermally degrade. For example, the impermeable barrier 140 degrades at the operating temperature of a dryer, preferably greater than about 50° and less than about 80° C.

Those skilled in the art can appreciate that any barrier or barrier configuration for minimizing or stopping substance loss is contemplated with in the scope of this invention.

Substance

In accordance with various embodiments of the present invention, a dryer device containing a substance in a porous body member to be dispersed throughout clothing in a laundry dryer by commingling and tumbling along side the clothing is provided.

For example, substances suitable for treating clothes in a dryer include, but are not limited to, at least one of a scent, a perfume, silicone oils, fabric softeners, fabric fresheners, fabric antistatic, fragrances, fabric anti-wrinkle compounds, fabric speed drying compounds, anti-allergenic, water-salt-mixtures, water-water soluble polymer mixtures, water-solvent mixtures and a skin moisturizer. In an exemplary embodiment, the substance comprises greater than about 2% and less than about 95% fabric softeners or fabric antistatics. Typical fabric softeners can comprise at least one of a quaternary ammonium, such as tallow ammonium ethyl sulfate (Adogen 66).

Additionally, the substance can comprise at least one of a solvent, a thickening agent, a surfactant and, optionally, an auxiliary ingredient. Wherein, suitable solvents include, but are not limited to, at least one of a C2-C22 alcohol (i.e. ethanol and isopropanol), a polyol (i.e. glycerin and propylene glycol), a polyethylene glycol (PEG-200), and a glycol ether (i.e. Dowanol® PM or Dowanol® DPM). Wherein, suitable thickening agents include, but are not limited to, at least one of a long-chain polyethylene glycol (i.e. PEG-8000), a solid quaternary ammonium compound (i.e. ethanaminium 2-hydroxy-N,N-bis-(2-hydroxyethyl)-N-methyl esters with C16-C18 and C18-unsaturated fatty acids, methyl sulfates). Also, wherein, suitable surfactants can comprise at least one of a nonionic release agent (i.e. Neodol® 45-7, C14-C15/7EO ethoxylated alcohol).

In another exemplary embodiment, the optional auxiliary ingredient comprises at least one of a solvent, a thickener, a surfactant, an emulsifier, a binder, an acid, a bases, a salt, a polymer, a dye, an odor absorber, an electrolyte, a bleach component, an oxygen-liberating ingredient, a peroxigen, an inorganic or organic absorbent, a clay, a buffer, a builder component, a chelant, an abrasives, a preservatives, a colorants, an anti-redeposition agent, an optical brightener, an enzyme, a soap, an anti-foaming agent, a cyclodextrine, a rheology-control agent, a vitamin, an oil, a nano-particle, a plastic particle and a bead. In another exemplary embodiment, the substance comprises at least one of a liquid, a gel, a granule and a sheet.

In one exemplary embodiment, the builder component comprises at least one of a carbonate, a sodium borate, a citrate, a ethylenediaminetetraacetic acid (EDTA), a zeolithe, a silicate and a polyacrylate. Further, the bleach component can comprise at least one of a perborate, a percarbonate, a surfactant, an enzyme, a wax, a binder, a disintegration aid, a perfume and a salt.

In an exemplary embodiment, the substance in the reservoir comprises a substance, which only migrates through a porous substrate in the EUI at the operating temperature of a dryer, preferably greater than about 50° and less than about 80° C. Examples of types of substances that only migrates through a porous substrate in the EUI at the operating temperature of a dryer include, but are not limited to a waxy paste, a liquid crystal, a thick liquid and an elastomer.

Those skilled in the art can appreciate that numerous substances and additives for treatment of clothes are known in the art and are contemplated within the scope of this invention.

Wick/Body Member

In various embodiments described herein, the present invention comprises a porous body member with an entrained substance for treating clothes by commingling and tumbling along side the clothes in the dryer. For example, in an exemplary embodiment, the porous body member is any porous member suitably configured to contain a substance for the treatment of clothing, wherein the heat of the dryer accelerates permeation of the substance into the porous body and to the outer surfaces where it contacts the tumbling fabrics, for example, by thinning the viscosity of the substance with heat and allowing for a greater capillary flow through the pores and channels in the porous body. Suitable porous body members include, but not limited to, a metered wick 304 depicted in FIG. 9 or a sponge. In an exemplary embodiment, the wick is porous plastic or cellulose fibers.

In another exemplary embodiment, the sponge comprises at least one of a urethane, an expandable plastic material, a polystyrene, a polyester, a polyether, a polypropylene (PP), a polyethylene (PE), a polyvinylchloride (PVC), a silicon, a cellulose and a starch. In another exemplary embodiment, the sponge comprises 14545 polyester-polyurethane sponge material from Flexible Foam. Additionally, the sponge can be impregnated, sprayed, injected, and/or soaked with the substances described herein. In this embodiment, the wetted sponge can act as the reservoir discussed above. By way of example, sponge impregnation can be accomplished with the “dip/nip” process. This dip/nip process comprises using uncut sponge boards that are compressed between at least two rollers, immersed into a bath of the substance while the sponge expands, such that the liquid substance becomes absorbed by the porous interior. Next, by applying pressure to the impregnated sponge the impregnated substance amount is controlled. In addition, the viscosity of the substance is adjusted by using elevated temperatures. Once the process is completed, the sponge boards can be cut for further processing.

Additionally, in a preferred mode the body member commingles with the clothes in the dryer. Any shape that allows for adequate commingling is contemplated herein. In other exemplary embodiments, the body member can comprise at least one of a cube, a cuboid, a sphere, an ellipsoid, any of the Platonic solids (tetrahedron, octahedron, dodecahedron), any spheroid (including, but not limited to, prolate and oblate spheroids), a cymbelloid, an amphoroid, or any elliptic prisms, such as the eunotioid, and any other shape that assists in commingling with tumbling fabrics. Additionally, the device surface can comprise a texture to assist in commingling and dispersion on substance. In other exemplary embodiments, the texture can comprise a pimple, a dimple, or other protuberances that improve the movement of the device amongst tumbling fabrics.

Both shape and composition of the body member contribute to longevity of the device, but two characteristics contribute to both the stability of the sponge during the application and the ability to provide a controlled release of actives for prolonged time, for example, within a range from about to 25-40 cycles. These two characteristics comprise specific density of the sponge and the Indentation Force Deflection (IFD). Thus, a sponge density greater than about 0.75 g/cm3 and less than about 4.5 g/cm3 is preferred. Most preferably, the sponge density is greater than about 1.0 g/cm3 and less than about 2.7 g/cm3.

Also, the IFD number represents the pounds of force required to indent a sponge sample by a specified percentage of its original thickness. This characteristic is measured with specially designed equipment. Typically, a 50 in2 round indentor plate is attached to a vertical piston-like cylinder having a precisely calibrated stroke. Firmness is measured on sponge samples having a square surface from about 15″×15″. Surface firmness is measured at 25% sample indentation (25% IFD). As an example, using a 4″ thick sample, the 25% IFD reading would be made while the sponge is indented to 3″ height under the piston foot plate (25% deflection of the sample height). Preferably, the sponge IFD is greater than about 20 and less than about 100. Most preferably, the sponge IFD is greater than about 30 and less than about 80. As graphically depicted in FIG. 5 the delivery of active ingredients by a sponge can be specifically tailored, using, for example, a sponge size of 6×10×9 cm having 24 grams of the active ingredients mixture, see preparation details contained herein.

Those skilled in the art can appreciate that numerous porous body members suitable to contain substances used to treat clothing in the dryer by commingling and tumbling along side the clothes are contemplated within the scope of this invention.

Casing

In some exemplary embodiments it may be desirable to encase the porous body member in a casing with sufficient flexibility and durability to withstand such mechanical forces to limit disintegration of the porous body member. The casing can be a net or a cage or a similar structure. Sufficient flexibility can be measured by an elongation factor, wherein the elongation factor is determined by multiplying the original length of the netting to the length which the netting material can be extended or stretched unidirectional under a constant force. In one exemplary embodiment, the netting comprises an elongation factor greater than about 1.2 and less than about 100. Preferably, the elongation factor greater than about 4 and less than about 40.

Further, in another exemplary embodiment, the cage is any plastic. Non-limiting examples of suitable plastics include, but are not limited to a polypropylene (PP), a polyethylene (PE), a polyethylene terephthalate (PET), a polyvinylchloride (PVC), a Nylon, a polystyrene (PS), and an acrylonitrile butadiene styrene (ABS).

In one exemplary embodiment, the netting comprises at least one of a natural and a synthetic fiber. The synthetic fiber can comprise at least one of a polyamide, a nylon, an elastan, a spandex, a polyester, a polyether, a melamine, and a propylene. Further, the natural fiber can comprise at least one of a cotton, a wool, a viscose, a rayon, a silk, and cellulose. In one exemplary embodiment, the fiber is woven or a non-woven. An example of a commercial product used for the netting material is, Fashion Knee high Sandalfoot, 96% nylon, 4% spandex, UPC code 071655013660, American Corporation, 389 Americal Road Henderson, N.C. 27537. Additionally, it is preferred that the netting is a mesh with a diameter less than about 4 mm, in the non-elongated state. Moreover, exemplary netting thickness comprises a thickness less than about 3 mm.

Moreover, the netting can comprise at least one of a heat sealable and an ultrasonic-sealable fabric. For example, a porous body member is covered from opposite sides with separate sheets of netting fabric and the opposing sheets are “welded” together using heat or ultrasound. Such process can be accomplished in approximately 0.5 to 3 seconds. It should be appreciated by those skilled in the art that other sealing configurations are likewise contemplated within the scope of this disclosure.

Those skilled in the art can appreciate that numerous casings suitable to protect the porous body members, commingling and tumbling along side the clothes in the dryer, are contemplated within the scope of this invention.

Dryer Device

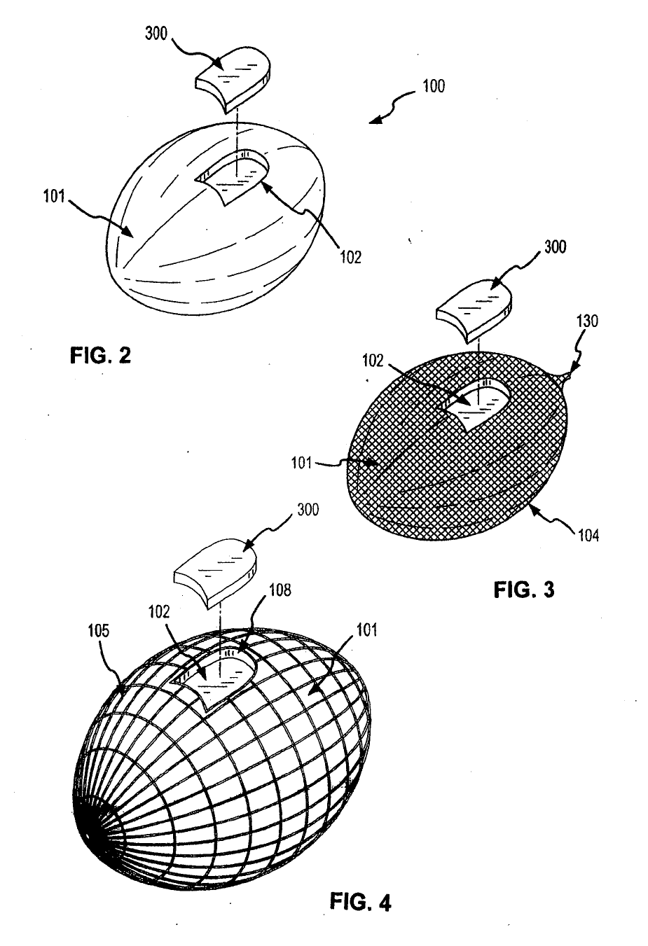

The constituent components of the disclosed dryer device have been taught by various non-limiting examples above and the novel combination of those components is herein set forth. In an exemplary embodiment, FIG. 2 illustrates one potential, complete dryer device 100 comprising of a body member 101 and a recess 102 for accepting a cartridge 300, wherein the body member 101 is free to tumble about the dryer and commingle with the clothing in the dryer. This cartridge 300 is a specific embodiment of the reservoir earlier described. All of the above recited exemplary embodiments apply to cartridge 300 and one of reasonable skill in the art will understand cartridge 300 to be a specific embodiment of the reservoir.

As for the coupling of the recess 102 and the cartridge 300, the components can be, but do not have to be rigid or semi-rigid. For example, if the cartridge is pushed into a more resilient recess, (a recess with surrounding walls that conform to the shape of the cartridge). Conversely, if the recess is more rigid them the cartridge the shape of the cartridge can be modified. In an exemplary embodiment, the cartridge is a bath soap pearl and the recess is foam, which easily deforms around the inserted soap pearls. Moreover, any recess 102 and cartridge 300 shape, wherein the cartridge fits substantially within the recess is suitable. For example, the recess and cartridge are cuboid and cylindrical. One preferred cartridge dimension is greater than 0.5 inch and less than 5 inches in length, greater than 0.25 inch and less than 3 inches in width and greater than 0.25 inch and less than 2 inches in height. Those skilled in the art can appreciate that numerous recess and cartridge shapes are contemplated within the scope of this invention.

In addition to shape of the cartridge 300, the volume should be sufficient to allow for prolonged use by the consumer, whether the cartridge 300 is a solid block of substance or a container as described above. For example, the interior capacity of the cartridge is preferably greater than 0.03 cubic inches (about ½ cc) and less than 30 cubic inches (about 475 cc). Regardless of shape for the cartridge, the preferred volume of the cartridge is greater than ½ cc and less than 475 cc. The most preferred volume for the cartridge is greater than 1 cc and less than 100 cc and the most preferred amount of substance within the cartridge is greater than 1 gram and less than 150 grams.

FIG. 2 further illustrates an exemplary prolate spheroid (football) shaped porous body member 101. Preferably, the dimension of the device is greater than about 1 inch and less than about 12. Most preferred is the prolate spheroid (football) with length from about 2 inches to about 10 inches and an equatorial diameter of from about 1 inch to about 5 inches.

Another example of a completed, dryer device is shown in FIG. 3, namely, FIG. 3 illustrates the body member 101 encased within a fine netting 104 and FIG. 4 illustrates a cage 105. As shown in both FIGS. 3 and 4, the netting 104 and cage 105 each do not obstruct the recess 102 that is configured to reversibly accept the cartridge 300. In one embodiment the netting shown in FIG. 3 extends across and down into recess 102, therefore not blocking the entry of the refill cartridge yet still making it possible to sheath the main body member inside a single continuous netting. It may be preferable to use contiguous netting that encases the body member and is pinched off in at least one end 130, or at multiple ends. The crimped or pinched off end or ends 130 of the netting 104 that encases the body member are closed with a zipper, tied or twisted closed with wire, plastic ties, string or the like, or the netting may be gathered and heat-melted or sonically welded to keep the netting fixed firmly around the main body member. The netting is then be pushed inside of the recess, being fastened within the recess with clips, staples, tacks, glue, heat-sealing or with other suitable fasteners, thus allowing access to the recess even though the netting is contiguous and extends across and into the recess.

Alternatively a hole in the netting may be lined up with the recess. In an exemplary embodiment, the netting comprises at least two pieces that are fastened. In an exemplary embodiment, the fastened pieces are stitched, glued, heat-melted, or sonically welded. In an exemplary embodiment, the netting comprises a pore size of greater than about 100 microns and less than about 5 mm. Similarly, it may be preferable to have a hole size greater than about 5 mm and less than about 20 mm in the plastic cage structure. In an exemplary embodiment, the cage is at least one of a square, a circle and an oval. In an exemplary embodiment, the cage itself has protuberances to improve the overall movement of the device amongst the tumbling fabrics. In an exemplary embodiment, the protuberances are spikes. As shown in FIG. 4, the cage 105 encases the body member 101 and a space 108 is molded or cut allowing for access to the recess 102. Alternatively, the cage is molded with a hinging or removable door that allows access to the recess 102.

In addition to the examples of dryer devices above, FIG. 5 depicts another embodiment of the present invention wherein the body member 101 comprises at least two separable body segments (101a and 101b). FIG. 5 also shows a fastening post 106 for reversibly fastening the separate body segments (101a and 101b) to form the body member 101 of the dryer device. In this instance, the recess 102 is configured as an inner cavity in the lower body segment 101b, but can be configured in anywhere in the body member. FIG. 5 shows window 107 in the body member making the EUI (described above) visible outside of the device. In this simple embodiment, the contents of the cartridge 300 remain viewable through window 107 when the cartridge 300 is positioned inside of the recess 102. In this embodiment, the end of use indicator is the transparent refill cartridge 300 visible through the view window 107 and the visual cue is simply the visible depletion of the contents. FIG. 5 also depicts a fastener 106 for fastening together the segments of the body member. In an exemplary embodiment, the fasteners comprise at least one of a post, a pins and hole, a dowel and hole, a snap, a bayonet point and bayonet provision and a pin that poke into foam.

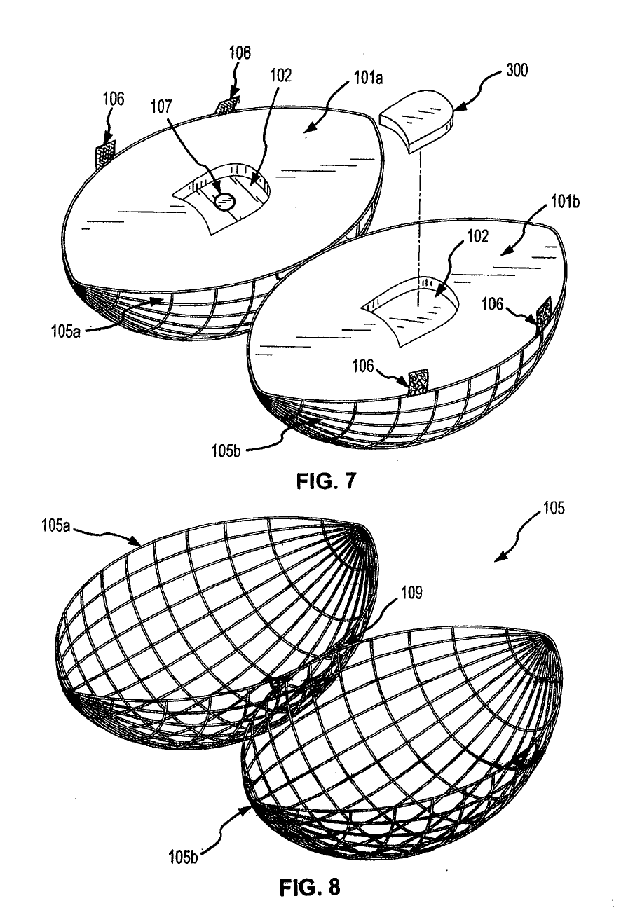

FIG. 6 illustrates another embodiment of the present invention wherein the body member 101 of the device 100 comprises two body segments (101a and 101b) and a hinge 109, which connects the body segments. In another exemplary embodiment, the body segments are fastened with fastener 106. In another exemplary embodiment, the fastener is on the outside of the body member. In this exemplary embodiment, the fastener comprises at least one of a loop of string and button or hook, a length of string for tying around the entire device, a Velcro® (a hook and loop fastener) strap and a strap with a snap. The fastener can be threaded arrangements, for example where one of the body segments threads into the other body segment. In another exemplary embodiment, the fastener is a cage 105 shown in FIG. 4. In another exemplary embodiment, the consumer replacing the refill cartridge 300 will 1) receive an EUI to be viewed through window 107, indicating the cartridge life 300; 2) separate the body member segments (101a and 101b); 3) remove the spent cartridge 300 from the recess 102; 4) place a new cartridge 300 into recess 102; and 5) close the device by reversible fastening the body segments (101a and 101b) together. An alternative embodiment is illustrated in FIG. 7 comprises separate body segments (101a and 101b) encased in a cage 105 comprising of two hingeably connected half cage segments (105a and 105b). In this way, the separate body segments essentially lay inside two basket halves that are hingeably arranged.

FIG. 8 more clearly depicts an embodiment of the present invention comprising a hinged cage 105 wherein the two halves of the cage form baskets to accept the two separate body member segments (described above). The cage comprising halves (105a and 105b) and a hinge 109 connecting the two halves. In another exemplary embodiment, the hinge is molded into the cage. In another exemplary embodiment, the hinge is a separate component that is fastened to the cage segments or to the body member segments. In another exemplary embodiment, the hinge is glued, clipped, stapled, pinned or hot-melted (or welded) onto the segments that are to be connected.

### Dryer Device Results and Examples

### Example 1

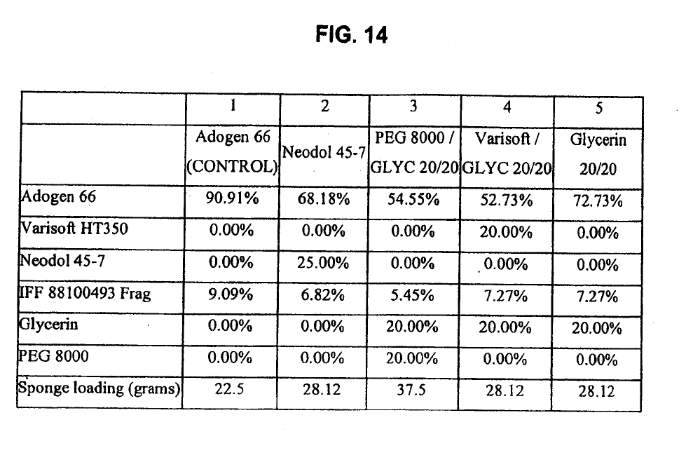

A device comprising a sponge body member was combined with various liquid or solid substances to demonstrate release of substances over repeated dryer cycles. Quaternary softening and anti-static actives were mixed with perfume and optionally solvents and thickeners to provide the solid or liquid substances. One formula, indicated as “Adogen 66-control” was used as the liquid substance control to compare against the other substances in the experiment. A second formulation indicated as “Neodol 45-7” comprised softener actives with nonionic surfactant as a release aid. A third formula, indicated as “Glycerin 20” comprised softener actives and a solvent as a release aid. A forth formula, indicated as “PEG 8000/GLYC 20/20” combined fabric softener actives with high-molecular weight polyethylene glycol (PEG-8000) for a substance that is solid at room temperature. Lastly a fifth formula, indicated as Varisoft/GLYC 20/20″ combined liquid fabric softener actives with a high-melting solid quaternary material as thickening agent to provide a substance that is also solid at room temperature. Each of these formulas are represented in the table provided in FIG. 14.

### Example 2

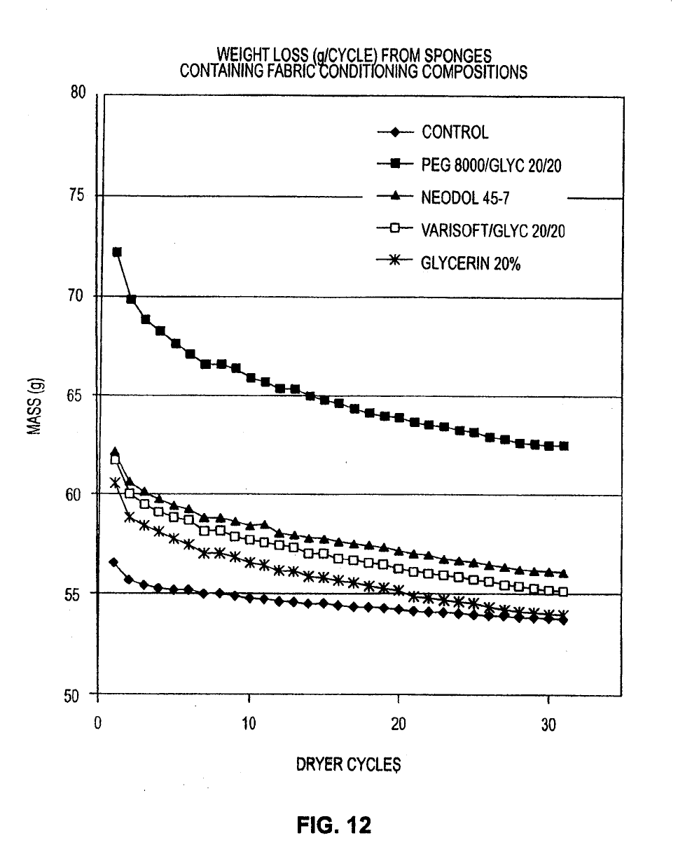

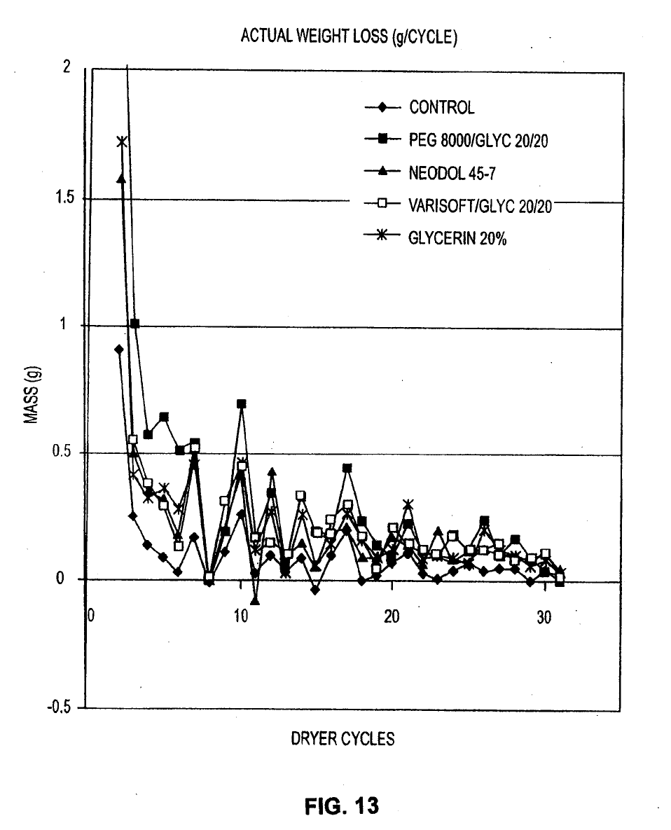

Each of the fabric treatment/conditioning substances (formulas 1-5 in FIG. 14) was heated until melted and were mixed with the perfume, solvent and thickening materials as appropriate for the specific formulas. Then 22.5-37.5 grams of each mixture was applied in the molten state to a 7×4×2.5 inch sponge material (Flexible Foam 14545 PU foam). The total amount of the actual fabric softener active was kept constant throughout the experiments. The repeat use dryer devices used in this experiment were made by covering each impregnated sponge from both sides with a non-woven netting material (ATEX spunbond polypropylene non-woven, type AXAR I sunflower/129, 51 grams/square meter. The non-woven pieces were then heat-sealed around the smaller edges of the sponge using an Aline Systems Corporation laboratory heat-sealer. The repeat use dryer devices were found to be useful for between about 25 to about 40 repetitive dryer cycles without disintegration of the sponges and with reliable delivery of the fabric conditioning substance to the fabric in the repeat dryer loads. FIG. 12 shows the release of various substances from the repeat use dryer devices over 32 repeat dryer cycles. The dryer appliance was a Whirlpool, and was set to HIGH heat and medium cycle length. Freshly washed loads consisting of 50 humid terry towels (each 20×15 cm and made from 50/50 cotton-polyester) were used in each dryer cycle. As can be seen in FIG. 12, each dryer device with the respective substance indicated released about 0.1 to about 0.8 grams of substance between about cycle #3 and cycle #30, and each was found to be delivering acceptable anti-static, softening and fragrance impact in each cycle across this range. The substances appear to release only very minor amounts of fabric conditioning substance after about 32 repeat dryer cycles, regardless of the substance within the sponge. FIG. 13 shows the actual (absolute) weight loss for each of the repeat use dryer devices mentioned above, (in grams per cycle).

### Example 3

In accordance with another embodiment of the present invention, a liquid containing refill cartridge for use within a repeat-use refillable dryer device was constructed. 4 Grams of perfume oil (IFF 88100493) and 20 grams of Adogen 66 were mixed and placed inside a 24 mL polyvinyl container. A thin PE membrane was heat-laminated across the lip of the opening to seal the container. The membrane was covered with a removable aluminum foil/PE foil laminate strip to prevent evaporation prior to use. A football shaped sponge toy (Poof® Pro Mini, 5½ inch mini-power spiral, from Poof Products, Inc, Plymouth Mich.) was used as the main body member of the device. The football was cut in half to produce two equal main body segments, and a recess with dimensions matching those of the 24 mL container was cut into each of the interior surfaces of the sponge halves. The refill fit snugly into this recess cut into the sponge. A window was cut in the outer surface of one half of the sponge toy to provide a view into the inner recess. Since the PVC container used for this experiment was transparent, the contents of the container were visible throughout the repeated dryer cycles, with the transparent container also functioning as the end-of-life indicator for the refill cartridge. Before inserting the refill cartridge into the recess between the sponge main body segments, the aluminum foil-PE foil laminate layer was removed so as to expose the semi-permeable membrane. The refill was placed within the two halves of the sponge football and the halves were then simply taped together with Duct® tape. The device with refill cartridge inserted inside was then covered with a reusable mesh washing machine bag (Woolite® brand bra wash bag). The refillable dryer device was used for over 25 cycles in a Whirlpool dryer appliance (conditions described above). The release of fabric conditioner substance was found to be very slow at room temperature but was accelerated with the heat present in the dryer cycles. It was observed that the refill cartridge was depleted of conditioner substance after about 23 dryer cycles. The visible emptying of the cartridge gave the visual cue (through the transparent walls of the container and the contents therein acting as the EUI) that the device required a new refill cartridge after about 23 repeat uses.

### Example 4

In accordance with another embodiment of the present invention, a refill cartridge comprising separate solid fabric conditioning substance and liquid EUI container was constructed for use in a refillable repeat-use dryer device. 2 Grams of perfume oil (IFF 88100493) and 0.0002 grams of a red oil-soluble dye (Cosmenyl Red BLS, CI 12490, Sandoplast Red G, or Solvent Red 135, CI 564120, from Clariant), was placed within a 2 mL polyvinyl container. The container was sealed by heat laminating a thin PE membrane across the opening. The membrane was covered with a removable aluminum foil-PE foil laminate strip to prevent evaporation prior to use. 2 Grams of perfume oil (IFF 88100493), 12 grams of Adogen 66, 5 grams of PEG 8000 and 5 grams of glycerin were melted at 80 C and mixed. The molten mixture was placed inside a 24 mL square shaped polypropylene bag that was previously perforated with 25 holes each measuring 0.2 mm in diameter. The bag was heat-sealed, then glued to the perfume/dye EUI container with a glue gun, forming a 2-container assembly. A 7″ round foam basketball toy (from Poof Products Inc., Plymouth Mich.) was used as the main body member of the refillable device. The ball was sliced into two halves, and enough foam material was removed from the center of the two halves to provide adequate space to accommodate the refill cartridge assembly. As before, a window was cut in one half to provide a viewing channel from the exterior of the ball into the recess within the interior of the ball. The refill assembly was found to fit snugly into this recess cut into the sponge interior. Since the PVC container used for the dye/perfume mixture was transparent, the contents of the container were visible throughout the repeat dryer cycles and the transparent container with dye and perfume mixture functioned as the end-of-life indicator for the refill cartridge, even though it is not part of the fabric conditioning substance (although it does impart fragrance to the fabrics). Before inserting the refill cartridge assembly into the recess in the center of the sponge main body segments, the aluminum foil-PE foil laminate layer was removed from the dye/perfume EUI container so as to expose the semi-permeable membrane. The ball halves were then placed together to hold the cartridge inside and the halves were held together with strips of Duct® tape. The device with refill cartridge inserted was then covered with a reusable mesh washing machine bag (Woolite® brand bra wash bag). The refillable dryer device was used for over 32 cycles in a Whirlpool dryer appliance (conditions described above in Example 1). The visible emptying of the dye/perfume container, occurring at 31 cycles, gave the visual cue that the device required a new refill cartridge. The release of fabric conditioner substance through the perforations of the bag was found to be very slow at room temperature but was accelerated with the heat present in the dryer cycles. The evaporation of the perfume/dye substance was found to closely parallel the release of solid fabric conditioner substance from the perforated bag.

### Example 5

The remaining example of an embodiment of the present invention comprised a liquid refill cartridge further comprising a wick. For the refill cartridge container and metering means, an empty Renuzit® Scented Oil Refill was used. This assembly is comprised of a small blow-molded polypropylene bottle, an injection-molded fitment and a polypropylene porous plastic molded wick. The bottle was filled with a mixture of 90% perfume oil (IFF 88100493) and 10% Adogen 66. For the main body member of the device, a football shaped sponge toy (Poof® Pro Mini, 5½ inch mini-power spiral, from Poof Products, Inc, Plymouth Mich.) was used. The football was cut in half to produce two equally sized main body segments, and enough foam was removed from the interior of each half to provide room for the refill cartridge. As before, a window was cut in one body member segment to provide a viewing channel from the exterior of the football into the recess within the interior of the ball. The refill assembly was found to fit snugly into this recess cut into the sponge interior. Since the polypropylene container used for the mixture was transparent, the contents of the container were visible throughout the repeat dryer cycles and the transparent container with contents functioned as the end-of-life indicator for the refill cartridge. The porous plastic wick was left exposed (i.e., not capped with a screw cap) and the refill cartridge comprising this bottle, fitment, porous wick and liquid contents was placed inside the cavity created in the middle of the football halves. The ball halves were then placed together to hold the cartridge inside and the halves were held together with strips of Duct® tape. The device with refill cartridge inserted was then covered with a reusable mesh washing machine bag (Woolite® brand bra wash bag) to guard against abrasion of the sponge device. The refillable dryer device as constructed was used for over 18 cycles in a Whirlpool dryer appliance (conditions described above in Example 1). It was observed that the fabric conditioning substance within the bottle released during each dryer cycle and that it was depleted after about 16 cycles. The visible cue that the bottle was empty of contents was the visible end-of-use indicator signaling the need to replace the refill cartridge within the device.

### Example 6

In accordance with an exemplary embodiment, the softener ingredients comprise about 90 grams of Adogen 66=ethyl bis-(polyethoxy ethanol) tallow ammonium ethosulfate (low melting point softening/antistatic agent, Degussa) along with about 10 grams of a perfume oil (HFC 04-8965, Henkel Fragrance Center). Next, 25 grams of the mixture is then applied into, for example, a 10×9×6 cm sponge material (Flexible Foam 14545 PU sponge). As part of an exemplary laundry care device, the device is further constructed by covering the impregnated sponge with a netting material (Fashion Knee high Sandalfoot, 96% nylon, 4% spandex, UPC code 071655013660, American Corporation, 389 Americal Road Henderson, N.C. 27537). The laundry care device can be used for about 25 cycles in the dryer without disintegration and delivers the softening ingredient and the perfume to the laundry.

In accordance with another exemplary embodiment, about 90 grams of a Methyl-bis-(hydrogenated tallow amidoethyl)-2-hydroxyethyl ammonium methyl sulfate (softener ingredient), is used along with about 10 grams of a perfume oil (HFC 04-8965, Henkel Fragrance Center). The softener ingredient is heated until melted and mixed with the perfume ingredient. 25 grams of the mixture is then applied in a molten state into a sponge material (Foamex PU foam, exact type to be specified), where it solidifies upon cooling. The sponge is next covered with a netting material (Fashion Knee high Sandalfoot, 96% nylon, 4% spandex, UPC code 071655013660, American Corporation, 389 Americal Road Henderson, N.C. 27537). The sponge can also be used for about 25 cycles in the dryer without disintegration and delivers the softening ingredient and the perfume to the laundry.

### Example 7

A plastic dot-based EUI indicator was manufactured such that an organic plastic material was impregnated with a perfume and an oil-soluble dye mixture that evaporates and fades at the operating temperature of a dryer (50°-80° C.). The plastic dot was made from polyvinyl acetate (ethylene-vinyl acetate resin, EVA resin, e.g. Du Pont Elwax 265). The Elwax 265 plastic dots are impregnated by leaving them for about 8-10 hours in perfume oil.

In an exemplary embodiment, 2 grams of Elwax 265 was mixed with 1 gram of perfume oil (HFC 96-5154) and 0.01 grams of an oil-soluble red dye (Cosmenyl Red BLS, CI 12490, or Sandoplast Red G, Solvent Red 135, C.I. 564120, Clariant). Several dots were attached with Loctite Super Glue to a piece of water-repellent paper and covered with a thin PE plastic foil (Reynolds Plastic Wrap, 200 sq. ft. (11⅝″)). The EUI was glued to the laundry care application. The plastic foil was removed to activate the EUI indicator. The kit was used about 25 cycles in a dryer appliance. It was observed that the evaporation of perfume causes a shrinking of the dots and the color fades away, so that after about 28 dryer cycles only a slightly reddish color can be seen. This indicates to the consumer that the application was ready for replacement.

### Example 8

In this exemplary embodiment, Red commercial latex paint (Sherwin-Williams SuperPaint® Interior Latex Paint or ProClassic® Waterborne Interior Latex Enamel) was used to paint a 2 cm diameter sized dot onto a polyester woven netting material. The painted netting was used as a replacement of the netting described earlier and acts as an EUI indicator. The kit was used over 25 cycles in a dryer appliance. It was observed that the dot wears off after about 27 dryer cycles, thus the application is ready for replacement.

### Example 9

In another exemplary embodiment, wax-based EUI indicator was attached. The wax-based EUI indicator is manufactured such that a dot of wax was placed on a porous substrate and covered with a protective coating. The wax then melts at the operating temperature of a dryer (50°-80° C.) and migrates along the porous substrate until it reaches a pre-determined mark of the indicator. The porous substrate was made from silica-coated paper or plastic (e.g. Whatman flexible TLC plates, Nr. 4410-221, silica gel 60 A with polyester backing, 250 um thickness) or a porous filter paper material or a chromatographic cellulose paper (e.g. Whatman 3MM Chr and similar types). Examples of suitable waxes or wax-like materials include silicone waxes (Silky Wax 103=53° C. (127 F), ST-Wax 303 (akylmethyl silicone wax)=75° C. (167° F.), all by Dow Corning), synthetic or natural polymers or polymer-plasticizer mixture, high MW polyethylene glycols (PEG1500=44-48° C. (111-118 F), PEG 4000=54-58° C. (129-136 F), PEG 6000=56-63° C. (133-145 F), all by Mallinckrodt JT Baker, Inc.), surfactant-water-mixtures (e.g. 70% sodium-laurylethersulfate (Texapon NSO)+30% water).

In this exemplary embodiment 0.1 grams of PEG 6000 and 0.001 grams of a red water-soluble dye (Vitasyn Ponceau 4RC 82, CI 16255) were mixed and placed on one end of a 1×5 cm Whatman flexible TLC plate and was covered with self-adhesive tape. The EUI indicator was attached with Loctite Super glue to the laundry care application. The kit was used over 25 cycles in a dryer appliance. It was observed that the heat causes the PEG-dye mixture to melt and migrate towards the distal end of the EUI indicator. After about 25 dryer cycles, the migration was complete; thereby indicating a new application was needed.

### Example 10

In this trial, 0.1 grams of ST-Elastomer 103 and 0.001 grams of a red water-soluble dye (Vitasyn Ponceau 4RC 82, CI 16255) were mixed and placed with the help of a syringe in one reservoir of a commercially available, emptied Timestrip® length-of-life indicator. The injection hole was sealed again with a drop of glue. The EUI indicator was attached with Loctite Super glue to the laundry care application in a manner described previously. The Timestrip® was activated by pressing the activation button. The kit was used over 25 cycles in a dryer appliance. It was observed that the heat causes the ST-Elastomer to migrate towards the distal end of the EUI indicator. After about 20 dryer cycles, the migration was complete, thus indicating that the application was ready for replacement.

### Example 11

Here, the clothing treatment substance comprises water and a polyhydroxylic solvent (propylene glycol, glycerin, polyethylene glycol), 2 grams of a mixture of 1.5 grams glycerin, 0.5 grams water, along with about 0.0001 grams of a blue water-soluble dye (Vitasyn Patent Blue V 85 01, C.I. 42051:2, Clariant) were placed in a 2 ml polyethylene container cavity. The container was heat-laminated with a polysulfone membrane. The membrane was covered with self-adhesive tape to prevent evaporation during non-use and the EUI indicator is attached to the laundry care application with Loctite Super glue. The tape is removed to activate the EUI indicator. The kit is used over 25 cycles in a dryer appliance. After about 23 cycles, a consumer can observe that the liquid has evaporated, thereby concluding that a new laundry care application is needed.

Further, 2 grams of a perfume oil (HFC 96-5154) and 0.0002 grams of a red oil-soluble dye (Cosmenyl Red BLS, CI 12490; or Sandoplast Red G, Solvent Red 135, C.I. 564120, Clariant) were placed in a 2 ml polyvinyl container cavity. The container was heat-laminated with a PE membrane. The membrane was covered with self-adhesive tape to prevent evaporation during non-use. The EUI indicator was attached with Loctite Super glue to the laundry care application as described earlier. The tape was removed to activate the EUI indicator. The kit was used over 25 cycles in a dryer appliance. Once observed that the evaporation of liquid was exhausted after 26 dryer cycles, the application was exhausted and a replacement was needed.

Further, 2 grams of a mixture of 1.7 grams glycerin, 0.3 grams water and 0.0001 grams of a red water-soluble dye (Vitasyn Ponceau 4RC 82, CI 16255) were placed in a 2 ml PE tube reservoir with a length of 6 cm and an inner tube diameter of 3 mm. The tube was covered with a plastic closure to prevent evaporation during non-use. The EUI indicator was attached with an adhesive tape to the inner door of a dryer. The closure was removed to activate the EUI indicator. The kit was used over 25 cycles in a dryer appliance. Once evaporation of the liquid was finished after about 25 dryer cycles, the application was identified for replacement.

What is claimed is:

1. A dryer device comprising:
a porous body member, wherein at least a portion of the body member comprises a reservoir and the body member is free to commingle with clothes tumbling in the dryer;
a substance contained in the reservoir, wherein the substance migrates through the body member; and
an end of use indicator coupled to the reservoir, wherein the substance migration induces a visual cue in the end of use indicator.

2. The device of claim 1, wherein the body member further comprises at least one of a plastic cage and a mesh netting.

3. The device of claim 1, wherein the body member is at least one of a spheroid, a cube, a cuboid, a sphere, and an ellipsoid.

4. The device of claim 1, wherein the body member comprises at least two segments fastened together.

5. The device of claim 1, wherein the body member is comprised of foam.

6. The dryer device of claim 1, wherein the reservoir is a solid block substance.

7. The dryer device of claim 1, wherein the reservoir is a refillable cartridge.

8. The device of claim 7, wherein the refillable cartridge comprises a plastic container.

9. The device of claim 1, wherein the end of use indicator comprises a transparent portion for viewing the visual cue.

10. The device of claim 1, wherein the substance comprises at least one of a scent, a perfume, a silicone oil, a fabric conditioning composition, a fabric softener, a fabric freshener, a fabric antistatic, a fragrance, a fabric anti-wrinkle compound, a fabric speed drying compound, an anti-allergenic compound, a water-salt-mixture, a water-water soluble polymer, a water-solvent mixture, and a skin moisturizer.

11. The device of claim 1, wherein the substance comprises at least one of a solvent, a thickening agent, and a surfactant.

12. The device of claim 11, wherein the solvent comprises at least one of an alcohol, a polyol, a polyethylene glycol, and a glycol ether.

13. The device of claim 1, wherein the visual cue fades as the substance is used.

14. The device of claim 1, wherein the visual cue comprises a chemical, which reacts with the substance in the reservoir.

15. The device of claim 1, wherein the visual cue comprises a degradable coating.

16. The device of claim 15, wherein the degradable coating degrades at the operating temperature of a dryer.

17. A dryer device comprising:
a porous body member, wherein at least a portion of the body member comprises a reservoir and the body member is free to commingle with clothes tumbling in the dryer;
a substance contained in the reservoir, wherein the substance migrates through the body member; and
an end of use indicator coupled to the body member, wherein a visual cue is induced in the end of use indicator independently from the migration of the substance through the body member.

18. The device of claim 17, wherein the visual cue is temperature dependant.

19. The device of claim 17, wherein the visual cue measures temperature cycles.

20. The dryer device of claim 17, wherein the reservoir further comprises a barrier between the substance contained in the reservoir and the end of use indicator, wherein the barrier degrades at the operating temperature of a dryer.
